(19) United States
(12) Patent Application Publication
(10) Pub. No.: US 2005/0140108 A1
(43) Pub. Date: Jun. 30, 2005

(54) Manual mini scooter

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/747,368

(22) Filed: Dec. 30, 2003

(51) Int. Cl. B62M 1/00

(52) U.S. Cl. 280/87.041

(57) ABSTRACT

A manual min-scooter includes a front fork and a wheelbase at the lower end of a handle tube; a lever extending backwards from a circumferential portion of the front fork; a rear wheel pivoted to the rear end of the lever; and a skateboard placed on the lever; the wheelbase including an axial, two buffer sleeves, a base, a bolt and a nut; two wheels respectively pivoted to two ends of the axial; the bolt penetrating the base and the two buffer sleeves at the middle section of the axial and then locked in place with the nut; and the base connected to the front fork at the lower end of the handle tube to provide for the handle tube linked to the wheelbase the same agility as that by the skateboard while taking a turn.

### BACKGROUND OF THE INVENTION

(a) Field of the Invention

The present invention relates to a manual mini scooter, and more particularly, a twin-wheel base adapted with an absorber is provided at the lower end of the handle tube to the handle at the front of the mini scooter so to provide similar torque and resilience to that given by the skating board when the two-wheel base is directly driven by the handle tube to achieve smooth turning and improve operating agility.

(b) Description of the Prior Art

Manual mini scooters generally available in the market are very popular for being compact, foldable and agile mobility. The manual mini scooter is basically an improvement of the conventional skateboard by adding a handle and a handle tube, a front fork extending from the lower end of the handle tube to support the board, a front wheel provided to the end of the handle tube, and a rear wheel to the rear end of the skate board. However, more structural members limit the speed of the skateboard and lack in the manipulation varieties with some of high difficulties. As a result, the manual mini scooter winds up a toy for the kids and on the verge of becoming a history since it hardly attracts the consumers.

Furthermore, the two-wheel manual mini scooter while in riding has the front and the rear wheels as the supports and the handle linked to the front wheel for turning control. In taking a turn, the rider controls the handle to turn the front wheel to the direction as desired; and the central gravity of the mini scooter slightly leans to one side for the front wheel to only partially contact the ground. As a result, the mini scooter is vulnerable to tilt over, making the entire mini scooter difficult to manipulate.

### SUMMARY OF THE INVENTION

The primary purpose of the present invention is to provide an improved structure of a manual mini scooter that gives similar torque and resilience to that of the skateboard for achieving more reliable turning and improving operational agility of the manual mini scooter.

To achieve the purpose, a front fork and a wheel base are provided at the lower end of the handle tube, two wheels are respectively pivoted to two sides of a wheel base; a lever is extended from a circumferential portion of the front fork backwards for the rear wheel to be pivoted to the rear end of the lever; and a skateboard is placed upon the lever to complete the frame for the manual mini-scooter. Wherein, the wheel base includes an axial, two buffer sleeves, a base, a bolt and a nut with two ends of the axial to respectively pivot to two wheels, the axial is bolted at its central section to the base and the buffer sleeves before being locked in position with the nut, and the base is connected to the front fork disposed at the lower end of the handle tube. Upon taking a turn, the wheelbase is controlled at the same time to provide the same agility as that given by the skateboard taking advantage of the resilience provided by the buffer sleeves in the wheelbase.

### BRIEF DESCRIPTION OF THE DRAWINGS

FIG. 1 is a perspective view of the present invention.

FIG. 2 is a sectional view of the present invention as assembled.

FIG. 3 is a schematic view showing that the present invention is taking a turn.

### DETAILED DESCRIPTION OF THE PREFERRED EMBODIMENTS

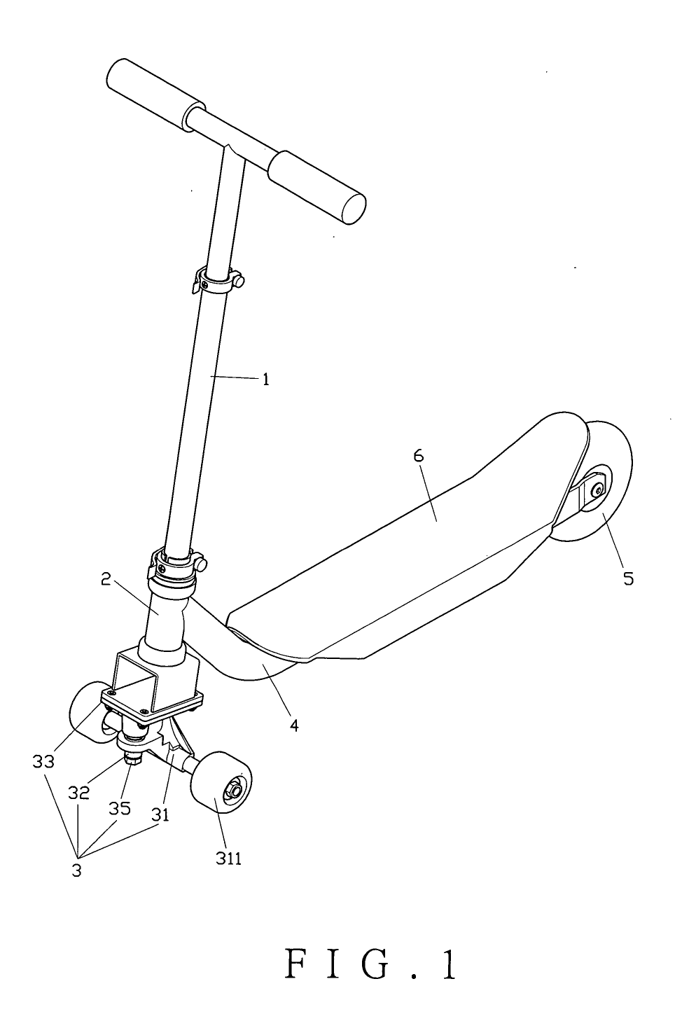

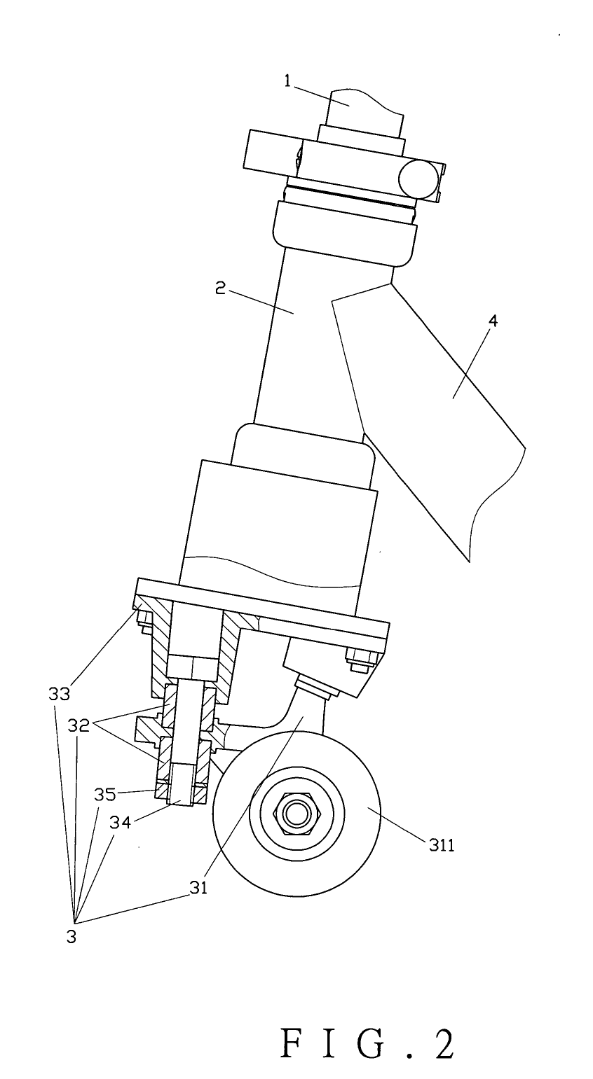

Referring to FIGS. 1 and 2, a preferred embodiment of the present invention of a manual mini-scooter essentially comprises a front fork (2) and a wheelbase (3) provided at the lower end of a handle tube (1); a lever (4) extending backward from a circumferential portion of the front fork (2); a rear wheel (5) is pivoted to the rear end of the lever (4), and a skateboard (6) is placed upon the lever (4) to complete a frame for the present invention.

The wheelbase (3) includes an axial (31), two buffer sleeves (32) and a base (33) locked in place with a bolt (34) and a nut (35). Each of both ends of the axial (31) is pivoted to a wheel (311), and the axial (31) is at its middle section penetrated by the bolt (34) to be fastened to the base (33) and the two buffer sleeves (32), and then locked in place with the nut (35). The axial (31) is further interlocked with the front fork (2) at the lower end of the handle tube (1) through the top surface of the base (33) so to indirectly be pivoted to the lower end of the handle tube (1) for being subject to the manipulation by the handle tube (1) as desired.

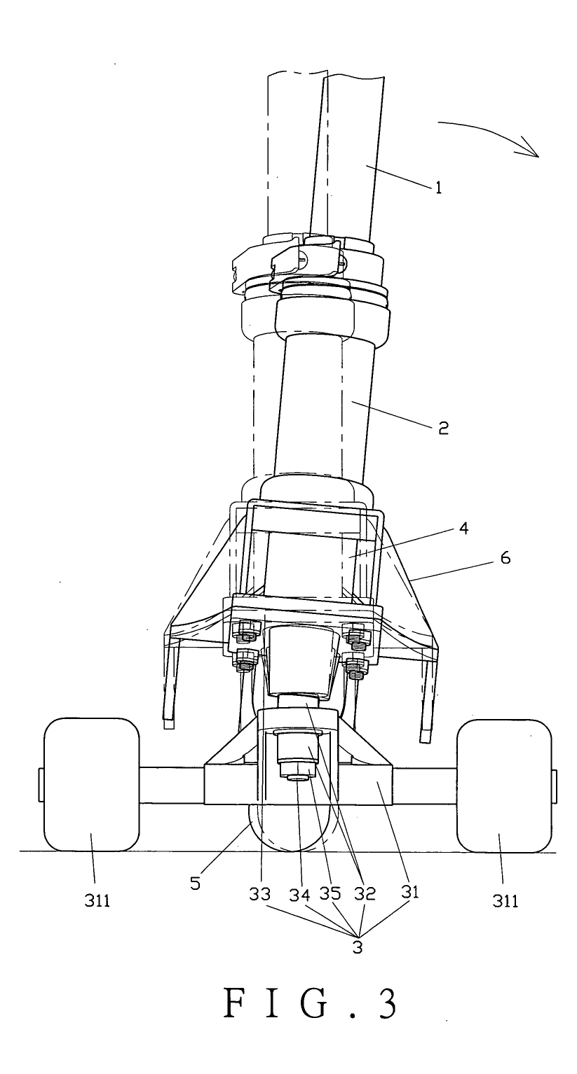

In practice, the rider controls the wheelbase (3) to take a turn through turning the handle tube (1). While taking a turn as illustrated in FIG. 3, the handle tube (1) inclines depending on the deflection of the central gravity of the user. As driven by the handle tube (1), the wheelbase (3) causes the bolt (34) fastened to the base (33) to slight compress against the buffer sleeves (32) while the wheels (311) pivoted to the wheelbase (3) remains firmly grabbing the ground to provide the torque and the resilience from the buffer sleeves (32) provided in the wheelbase (3) required in taking a smooth turn and for the manual mini-scooter of the present invention to indicate the same agile manipulation as with the skateboard.

1. A manual min-scooter comprising a front fork and a wheelbase provided at a lower end of a handle tube; a lever extending backwards from a circumferential portion of the front fork; a rear wheel being pivoted to a rear end of the lever; and a skateboard being placed on the lever; the wheelbase including an axial, two buffer sleeves, a base, a bolt and a nut; two wheels being respectively pivoted to two ends of the axial; the bolt penetrating the base and the two buffer sleeves at a middle section of the axial and then locked in place with the nut; and the base being connected to the front fork provided at the lower end of the handle tube.
